(19) United States
(12) Patent Application Publication
(10) Pub. No.: US 2019/0213875 A1
(43) Pub. Date: Jul. 11, 2019

(54) DISTRIBUTED TRAFFIC GUIDANCE AND SURVEILLANCE SYSTEM

(71) Applicant: Roger Andre Eilertsen, Askim (NO)

(72) Inventor: Roger Andre Eilertsen, Askim (NO)

(21) Appl. No.: 16/333,951

(22) PCT Filed: Sep. 15, 2017
(86) PCT No.: PCT/NO2017/000023

§ 371 Date: Mar. 15, 2019

(30) Foreign Application Priority Data
Sep. 16, 2016 (NO) 20161473

(51) Int. Cl. G08G 1/01

(52) U.S. Cl. CPC G08G 1/0133; G08G 1/0145; G08G 1/0112

(57) ABSTRACT

A distributed traffic and information system is disclosed comprising a consistent distribution of user registrations of the system in a plurality of home servers hosting user profiles of users being associated with respective limited districts of a city or a rural place, and wherein an address structure facilitate identifying a live GPS positions of road users moving around, and wherein a specific identified GPS position can be used to identify a user identification of the road user associated with the GPS position.

### RELATED APPLICATIONS

This application is a national stage filing under 35 U.S.C. 371 of International Application No. PCT/NO2017/000023, filed Sep. 15, 2017, which claims priority to Norway Application No. 20161473, filed Sep. 16, 2016. The entire teachings of PCT/NO2017/000023 are incorporated by reference herein.

### FIELD OF THE INVENTION

The present invention is related to a distributed traffic guidance and surveillance system comprising a plurality of physical and/or virtual traffic base stations serving road users within respective geographical coverage areas associated with the respective physical and/or virtual traffic base stations.

### BACKGROUND OF THE INVENTION

Modern cars are changing their appearance from petrol driven speed monsters to electric and environmentally friendly computer driven machines. Many modern cars needs software updates from time to time provided over the Internet instead of changing oil from time to time at a workshop. In a sense, many modern cars are computers equipped with wheels and an electric motor.

Despite the “modernity” of new cars, one problem remains despite the new technology, and that is the number of cars on the roads.

Cities have evolved with an infrastructure with constraints inherited from city developments from as far back in time as the antique. Modern city planning and modernization has improved the situation. However, the main traffic problem due to a huge number of cars on the roads is of course congestions of cars on respective roads that may block traffic for hours.

Traffic flow problems are an area of interest in many mathematical disciplines like queueing theory and flow theory.

However, mathematical traffic flow theory has not yet produced any lasting solutions to the traffic congestion problems of cities. The main problem is that the mathematical analysis usually provides forecasts, which has variable reliability and duration. Further, traffic is subject to random incidents like road traffic accidents, which one cannot foresee. Some aspects of the theoretical works have produced some meaning full principles regarding guiding traffic.

For example, it is common to look at game theory and one important concept is the concept of Nash equilibrium. A simple way of explaining the concept of the Nash equilibrium related to traffic is by a simple example of two road users. Road user A and road user B are in Nash equilibrium if road user A is making the best decision for a travel route by taking into account road user B's decision for his travel route, and road user B is making the best decision he can by taking into account road user A's decision. Likewise, a group of road users are in Nash equilibrium if each one is making the best decision about the traffic that he or she can do by taking into account the decisions of the others in the traffic.

Another interesting aspect of road conditions is how road capacity influences traffic flow. A German mathematician Dietrich Braess found what is denoted as the Braess paradox. The paradox states that adding extra capacity to a network when moving entities selfishly choose their own routes in the network may reduce overall performance. This is because the Nash equilibrium of such a system is not necessarily optimal. Selfish behavior does not favour cooperation between road users in the traffic.

For example, in Seoul in South Korea an increase in traffic flow capacity around the city happened when the city removed an existing motorway segment. In Stuttgart in Germany, in 1969, a new road network did not provide the expected improvement in travel time before closing a new section of the road for traffic. The same phenomena occurred in New York City in 1990 when traffic on the 42^{nd} street was blocked. This reduced the traffic congestion in the area.

Frank Knight did some of the first attempts to produce a mathematical theory with respect to traffic flow in the 1920s. The attempts provided a theory of traffic equilibrium, which was refined into Wardrop's first and second principles of equilibrium in 1952.

Even with the significant computer processing power that exists today there has been no substantial results from systems applied to real traffic flow conditions. Current traffic models use a mixture of empirical and theoretical techniques. These models then make traffic forecasts and the forecasts try to identify areas of congestion where the current traffic on roads needs rerouting for example.

Beside the theoretical approach to traffic flow theory, most cars are today equipped with navigation systems, or users may have downloaded navigation apps to their smart phones. The Global Positioning System (GPS) makes it possible for navigation terminals to identify geographical positions of GPS transceivers located inside the navigation terminals, smart phones etc. and the changing and recorded positions of the GPS transceivers may be plotted on computer implemented maps residing in the navigation terminal or mobile phone. Then, road users may for example view the moving position on roads in the computer implemented map being displayed on a terminal display they can view.

Another example of use of GPS transceivers is letting a centralized computer system collect GPS positions from a plurality of cars and use the number of cars as basis for indicating traffic flow conditions. For example, Google Maps indicate traffic flow conditions with different colour. Green is for open roads, yellow is for roads with high traffic density, while red coloured roads experience congestions or are blocked.

Cars equipped with Internet and an Internet connected terminal may then view for example WEB pages displaying roads with traffic indications around the position the road user is located on at any time. However, it is still difficult to identify at which moment in time a yellow road for example turns into a red road, and vice versa. Identifying such an event before it actually happens would be beneficial for any specific new road user entering the yellow or green road. Specific road users already on the yellow or green road should be cautioned about the upcoming event and maybe be told to start to look for alternative routes away from the road. It is then rather obvious that a red road condition might be avoided, or at least lasting a much shorter time-period since fewer cars would be involved or trapped on the road.

An aspect of the present invention is therefore to be available to identify probable changes of traffic conditions before conditions actually has manifested themselves. For example before a queue is actually an established queue, and further being able to inform affected road users about probable changes of road conditions by informing the affected road users on an individual level, and not just as one among many road users on a collective level.

Navigation terminals may also benefit from such information, and may automatically propose alternative routes. However, it is known that navigation terminals uses the same algorithm (Dijkstra's algorithm) and will propose the same alternative roads to every road user using the system in an area with traffic congestion, and the problem is shifted to other roads. Therefore, a further aspect of the present invention is that individual guiding of road users might mitigate traffic problems induced by collective guidance of road users from traffic guidance systems.

Despite the apparent benefit of being informed about traffic problems, it seems impossible for all people to find any alternative routes guiding them around any traffic problem. People tends to be trapped in traffic congestions. Some traffic problems are related to sudden random accidents. Then a congestion may build up rapidly, and the random aspect makes it difficult, and sometimes impossible, to detect the event in advance of the event.

In prior art it is believed that deploying sensors around roads may help detect upcoming traffic problems like congestions. However, there are some problems with the measurement technique. If a sensor counts passing cars, and if there are no cars passing, the road seems to be “green,” i.e. open. However, if there is congestion and the queue stands still, the sensor will detect no moving cars, i.e. the road might wrongly be detected as “green.”

Therefore, sensor technology as such has often proved to be inadequate. A further development of sensors trying to mitigate such measurement problems is the concept of distributing intelligent agents around roads and/or among road users etc. Traffic and transportation systems are well suited for an agent-based approach because of the geographical distribution, and due to some aspects of the behavior of the traffic. There exists an international standard for intelligent agents supported by the Foundation for Intelligent Physical Agents (FIPA). When managing traffic problems the most appealing characteristics of agents are their possible ability to react quickly to traffic incidents. In a multi-agent system (MAS), agents communicate with other agents in a system being adapted to be a distributed problem-solving system. Further information about FIPA and intelligent agents is disclosed on http://www.fipa.org/.

The theoretical mathematical approach to traffic has provided some important findings, but according to an aspect of the present invention, road traffic is subject to many constraints related to actual travel routes, which influence what road users actually can do. For example, cars drives forward along a road on a specific marked lane on the road surface. Therefore, the number of different movements a road user can do with the car is extremely limited. Essentially, it is the forward driving direction that is at disposal to the driver. It is sometimes, but not always, possible to drive to the side of the road and stop the car. It may also sometimes be possible to make U-turns and drive in the opposite direction along adjacent lanes being allocated to this driving direction.

In a sense, road traffic is a collective experience despite the use of individual cars due to the constraints imposed on possible driving directions. An interesting consequence regarding the collective behavior is that most cars on a same road segment behave the same way in the traffic due to the limited number of possible driving directions of a car. When the traffic flow is high, cars tends to be closer to each other, which again implies that they will drive along in a same direction at the same speed etc. Therefore, a further aspect of the present invention is that it is not necessary to measure movements of every road user or car to be able to acquire reliable traffic measurement data indicating traffic conditions.

An aspect of the collective feature of traffic is that when normal traffic conditions are present, road users tends to be driving with some distance between them primarily out of security reasons. If a car in front of another car starts to brake, the road users behind needs a few seconds to react, and during the reaction time period, the speed of the car behind is larger than the speed of the braking car in front. Thereby the distance between the cars decreases. If the situation is the start or trigger of traffic congestion, cars farther behind will catch up with cars in front of them. Interestingly, like a paradox, the reaction time is packing cars closer to each other in the queue freeing road capacity behind the cars slowing down. If the cars slow down or even stop moving due to the queue, and then more cars can be present on the road. A simple example illustrates the situation. If there are 2000 cars on a road segment and the average distance between the cars is three meters when driving on the road under normal condition, an upcoming congestion would probably reduce the average distance between cars to one meters. Theoretically, the packing of cars results in 4000 meters of road capacity that may start to be filled with new arrivals of further cars. When the congestion starts to dissolve a reaction time of road users of one second would create a delay of 2000 seconds among the first car to start to drive normal again compared to the last of the original 2000 cars. This is a simplified description, but illustrates some aspects of collective features of traffic in general.

In prior art there is a development of vehicle-to-vehicle networks that might allow a braking car to send a signal backwards to cars behind that a braking happens in front. However, this reduces the reaction time of each respective driver, but the packing of cars will still happen. The normal individual human behavior is to drive closer to each other when the speed is slowing down. When congestion starts to dissolve, a vehicle-to-vehicle network could detect a speeding up condition of a car in front of a queue, which can be sent as signals informing cars behind about the good news, and even automatically start to speed up the cars behind thereby reducing the latency of the queue dissolving process. However, it is normal human behavior to establish a safety distance of for example three meters anyhow, which implies that a car behind would drive slower than a car in front to be able to re-establish for example a safety distance.

A further observation is that dissolving of a queue may take a considerable amount of time, not just because of the reaction time delays as discussed above, but road users in front of the queue starts to be used to drive slowly, which they probably might have done the last hour. The reason is that they do not see what is happening in front of them in the traffic, for example around a house corner in the city or a bend of the road in the countryside. Even if a vehicle-to-vehicle network provides information from cars around the corner, many road users would still not speed up correctly until they are around the corner, or the bend of the road, and can see for themselves that the queue is over. In a sense, individual road user behavior may induce collective traffic problems. According to an aspect of individual guidance according to the present invention, individual information and guidance delivered to road users adjacent to areas with traffic problems can mitigate collective traffic problems.

Road traffic information systems usually do not inform road users on a direct personal level, which could be used to inform drivers in front of ques etc. to speed up.

A further collective aspect of traffic conditions is the amount of available “asphalt” left on a road segment that can be filled with further cars on roads. Most prior art systems counts cars and frequency of cars passing junctions etc. when identifying traffic flow conditions.

Road users approaching a road segment from behind will not spot the possible queue problem in front of them because many thousand meters of the road may seem to be a “green” road as discussed above. If for example Google maps has coloured the road “red,” most road users coming into the road segment from behind, for example form a side road, would believe that Google maps has made an error. They will believe their own eyes and act individually and start driving into the road they see is “green.”

When the whole road segment is filled with cars, the extra cars entering the road will contribute in delaying the dissolving of the queue considerably. This is of course a simplified description, but it illustrates the complexity of understanding and detecting available asphalt, or available road capacity. In one sense the available asphalt is available, but on the other hand, actually might be a resource causing severe problems if the available road capacity is utilized by humans not seeing that the road is problematic, or due to selfish human behavior ignoring warnings from traffic guidance systems.

Therefore, a measurement of changes in distances between cars may comprise a signal about upcoming traffic congestion before the congestion actually has manifested itself. If the distance between cars consistently starts to decrease a probable queue may start. On the other hand, if distances between cars in a queue start to increase consistently, it is a signal that a queue might be starting to dissolve. A further aspect of the present invention is not just to measure distances on road segments when such conditions are starting to develop. Investigating car distance development ahead of a road segment experiencing packing of cars can identify the geographical point or limited area wherein the packing of cars starts which by definition will be adjacent to a road segment wherein car distances starts to increase again, or are just normal (has been normal all the time). The geographical point or limited area joining a road segment with packing of cars with a road segment with normal condition (or improving condition) is dynamically changing. If the joining area or point moves forward in the driving direction, the queue problem is increasing. If the joining area or point moves backwards the queue problem might be over, or the initial measurement of decreasing car distances was not an indication of a real queue problem.

Therefore, there is a need of a traffic guidance and traffic information system providing improved traffic measurements as well as individual guidance to road users.

### OBJECT OF THE INVENTION

In particular, it may be seen as an object of the present invention to provide a distributed traffic and information system comprising a client/server architecture facilitating identifying live geographical positions of road users as well as identifying user identities by identifying a GPS position of a moving or stationary object associated with a registered road user.

It is a further object of the present invention to provide an alternative to the prior art.

### SUMMARY OF THE INVENTION

Thus, the above described object and several other objects are intended to be obtained in a first aspect of the invention by providing a distributed traffic guidance and information system comprising:
a plurality of distributed home servers (HS) hosting user profiles of registered road users associated with respective areas served by each respective home server (HS), and a plurality of distributed traffic base stations (TBS) serving respective road users being at any time within a defined geographical service area around each respective traffic base station (TBS);
the home server (HS) is configured to assign a unique user identification (user-ID) of each registered road user that is unique with respect to user registrations of other road users being registered in other home servers (HS) serving other districts or rural regions;
wherein each registered road user is associated with a traffic client system (TC) system providing communication between a specific road user logical address and the home server, wherein the traffic client system (TC) corresponding to each registered road user is updated with their current GPS position at any time on the respective user profiles of the road users;
wherein when a road user enters a service area of a traffic base station (TBS), the traffic client system (TC) is connected to the traffic base station (TBS), and the traffic base station (TBS) receives a copy of the logical address; and
maintains the connection and the home page address only as long as the road user is within the service area of the traffic base station (TBS).

Further objects are intended to be obtained by a method of identifying congestions on roads by using a distributed system according to the present invention, wherein a traffic base station (TBS) according to the present invention is configured to perform steps of:
initiating a time correlation step when reading GPS positions from a plurality of cars driving on a road in the same driving direction within the service area of the traffic base station;
recording the time correlated GPS positions; and
initiating an analysis of the series of correlated GPS positions to determine if there is a consistent decreasing distance between the cars, or if there is a consistent increase in the distance between the cars.

Respective aspects of the present invention may each be combined with any of the other aspects. These and other aspects of the invention will be apparent from and elucidated with reference to the embodiments described hereinafter.

### DESCRIPTION OF THE FIGURES

The method and system thereof according to the present invention will now be described in more detail with reference to the accompanying figures. The accompanying figures illustrates an example of embodiment of the present invention and is not to be construed as being limiting to other possible embodiments falling within the scope of the attached claim set.

FIG. 1 illustrate an example of embodiment of the present invention.

FIG. 2 illustrate an example of embodiment of the present invention.

FIG. 3 illustrates an example of embodiment of the present invention.

### DETAILED DESCRIPTION OF AN EMBODIMENT

Although the present invention has been described in connection with the specified embodiments, it should not be construed as being in any way limited to the presented examples. The scope of the present invention is set out by the accompanying claim set. In the context of the claims, the terms “comprising” or “comprises” do not exclude other possible elements or steps. The mentioning of references such as “a” or “an” etc. should not be construed as excluding a plurality. The use of reference signs in the claims with respect to elements indicated in the figures shall also not be construed as limiting the scope of the invention. Furthermore, individual features mentioned in different claims, may possibly be advantageously combined, and the mentioning of these features in different claims does not exclude that a combination of features is not possible and advantageous.

When GPS positions of cars are plotted in Google maps for example, this is usually done over the Internet in a communication protocol denoted connectionless communication. The GPS data sent from cars is datagrams according to the Internet standard, which implies that the data packages do not contain a sender address, but only the address of the destination. If a package is lost, it is not a problem. It will just appear as a missing dot on a more or less continuous line in the map.

Therefore, there is no means of directly identifying an individual car, or road user, when viewing a displayed symbol on a map visualizing the movement of the car the road user is driving, for example by pushing a symbol on the display screen representing a moving car.

Connection oriented communication, which establish a lasting logical bidirectional communication capability, would be preferable, but requires large computer resources to establish and maintain. When one takes into account the huge number of cars driving in the large cities of the world, it is apparent that this is just possible to do in theory, but usually not in a practical manner in reality. Therefore, a single server system serving a plurality of clients in a server/client architecture seems difficult to establish in a traffic guidance and information system if permanent contact with users are established.

Therefore, distributed solutions according to a server/client architecture wherein clients sometimes also can be servers, and servers be clients, is a known technology to mitigate the load and balancing problems of centralized computer systems. Computer process to computer process communication is an integral part of the TCP/IP protocol as known to a person skilled in the art, which facilitates data sharing between computers in a client/server system. There are also other embodiments of such principles like named pipes, anonymous pipes etc.

However, if one needs to address a moving car, for example when the car is in front of a queue that is dissolving, and be able to instruct the car to increase speed for example, it is actually necessary to identify the car or road user according to the moving GPS position of the car or road user. The GPS position can be displayed for example on a map. Therefore, an address providing such capabilities must somehow comprises an address field comprising a variable GPS coordinate that may change all the time.

It is important to understand that a logical address may be utilized to contact a road user, for example via an Internet address or a mobile telephone number, but then one has to know the identity of the road user. The address scheme according to the present invention serves at least two purposes: 1) If one knows the identity of a road user, the address scheme finds the geographical position the road user at any time is located on. This is denoted forward addressing. The reverse addressing is also possible. When a GPS position of an unknown road user is identified, the address scheme allows following the address from the GPS position back to the user identity associated with the GPS transponder submitting the GPS positions.

Therefore, the address scheme according to the present invention may be denoted physical addressing instead of logical addressing.

According to an aspect of the present invention, an address of a road user is configured to reflect the geographical position of a road user at any time. If the identity of a road user is known, the address scheme makes it possible to directly identify the geographical location the road user is located on. Since the geographical position of a road user changes all the time, an example of embodiment of the present invention can display a map segment indicating the moving position of the road user as the identification of the geographical position. Then any human or computer process in a server or client may establish for example a communication channel, including voice communication, with the identified road user.

The reverse address look up is also possible. If a road user, or computer process, for example is viewing a map section visualizing moving points of a road user, the address scheme of the present invention allows identifying a complete address of a road user that is unique for the specific road user, and thereby identifying the identity of the road user. This is possible by following the address scheme in reverse order from a current GPS position of a user to a unique user identity allocated to the user by the system.

The inventor has been inspired by the solution in prior art of how mobile cell phone systems operates. Regardless of where a mobile phone is located, anyone can call the phone from anywhere if one knows the telephone number provided for by a local telecom company.

In analogy with a base station of a mobile network, an aspect of the present invention uses a virtual traffic base station (TBS) having a geographical coverage area, or service area, around each respective TBS of a certain extent. When a road user enters a TBS service area, a computer terminal like a navigation tool, or mobile phone, or an embedded computer in the car, etc., denoted a traffic client (TC) of the car, signals the TBS of its presence in the service area of the TBS. Further details of how these steps operates is described below. When the road user drives out of a specific service area (or cell) into a next service area (or next cell), there will be a soft handover of the TC to a next TBS serving the next service area. More details are disclosed below.

According to an example of embodiment of the present invention, a road user will register himself as user of the system in a server reserved for the residential area of the road user. For example, a road user living in Oslo in Norway will access a server with an Internet address comprising address elements of Norway.Oslo.District. The server, denoted home server (HS) may be a virtual or physical server being part of a larger physical server system. The generic form of the address of the HS will be:

country-code.city-code.district-code.

Further, if the Internet address country-code.city-code.district-code is amended with a unique user identification provided for registered road users of the HS, the following address of the users is established:

country-code.city-code.district-code.user-ID.

Therefore, since the user identity is unique the whole address is unique for each registered road user, also across all districts. Such an address is easily translated to an Internet address pointing to for example a WEB page, and/or a user profile etc. hosted by the home server HS, which can be regarded as a home page for the road user. It is also possible to have sub-pages allocated to the address. Further, the unique address makes it possible to establish process to process communication between the HS and other processes in other computers sharing user data etc. being pre-stored at the time of registering a user, or which are interactively being updated by other computer processes or other users of the system.

When a road user is registering as a user, the traffic client TC selected by the road user is initialized with the web address of his profile hosted by the HS and a system allocated address of his selected TC.

When a road user is driving around in his car his geographical position is changing all the time. Therefore, within a further aspect of the present invention, the address of a road user may be amended with the current GPS position as well, i.e.

country-code.city-code.district-code.user-ID.current-GPS.

A road user coming online, for example when starting the car in the morning, triggers the TC associated with the road user to contact the home server HS where the road user is registered (or the user triggers the action). The HS system reads out the current GPS position from the TC and identifies the approximate geographical position of the road user. If the road user is temporarily located in another country for example, the HS contacts for example a top node server of the country. The top node server may then use the GPS position submitted from the HS to identify the city (or region) in the country the user is located, and the city (or region server) identifies a district server allocated to the district the user is located. If the city or region is small in population the city and district server may be the same server. Based on the transferred GPS position the city server (district server) identifies which one of the traffic base stations TBS in the district that can serve the road user. The TBS receives the address of the TC associated with the road user. The TBS can be configured to maintain a computer coded map of the limited geographical area the TBS is configured to serve. Then the TBS can read out the current GPS position and update the position in the map. The TBS can further be configured to maintain a table of GPS positions of each TC (for example using the TC address as the table identifier) being inside the geographical area of the TC at all timea.

When a temporary address of the road user is identified according the scheme disclosed above, the temporary address comprising the current country code, city code, district code, traffic base station address etc., is updated in the user profile of the road user residing in the HS. Therefore, when another road user or computer process is contacting the road user via the unique address of the road user being associated with the HS server, the HS automatically follows the temporary associated address pointing to the dynamic GPS position the road user is located all the time. For example, a copy of the computer coded map of the service area of the TBS serving the road user can be transferred or viewed by the contacting road user. Thereby telling the contacting road user exactly where the road user is located by displaying the moving or stationary GPS position of the road user in the computer coded map section updated by the TBS.

A reverse addressing is also possible. For example, a symbol representing a specific road user position in a map may be selected, either by pushing a finger on a display, or a search algorithm initiated by a process identifies the symbol and associated GPS position.

When a road authority is in need of contacting specific road users in a geographical area, for example due to possible terrorist activity, large fires, hazards of explosives being stored in the area etc., or is a road user driving in front of a queue the searching can be initiated by the authority. Based on the location of the incident requiring the attention, the searching algorithm may send an identified GPS position of respective road users of interest through an identification process according to the present invention. If the authority has a computer coded map at disposal, the map may be updated with the geographical positions of the TBS(s) located in the area, for example from the city server, or district server. In an embodiment of the present invention, a warning message to the road users of interest can be sent from the authority just by pasting a message on top of the respective symbols representing the at least one traffic base station TBS being located in the area having a coverage area the road users are within. Then the TBS can submit the message to the road users via the recorded TC address being dynamically maintained by the TBS.

The tables associated with the TC addresses are maintained with the respective GPS positions. When one tries to contact a single road user, or needs to identify the road user driving the car, pushing the symbol on map may identify the GPS position as known to a person skilled in the art. Then the GPS position may be submitted to an identification process that may start at the top node of the country. Based on the current GPS position the TBS serving the road user is identified, and by searching recorded GPS positions in the TBS, the TC address associated with the GPS position is identified, and hence the TC address is identified etc. Alternatively, the map used when pushing the symbol representing the road user may comprise an information layer with the positions of respective TBS servers. Then a simple algorithm running in the computer hosting the computer coded map can identify which TBS is serving the road user based on comparing the size of the service area with the current GPS position and decide which service area the GPS position is within. Then an address of the specific TBS can be for example be part of the information layer and the TBS serving the road user can be contacted directly and the message for example can be sent.

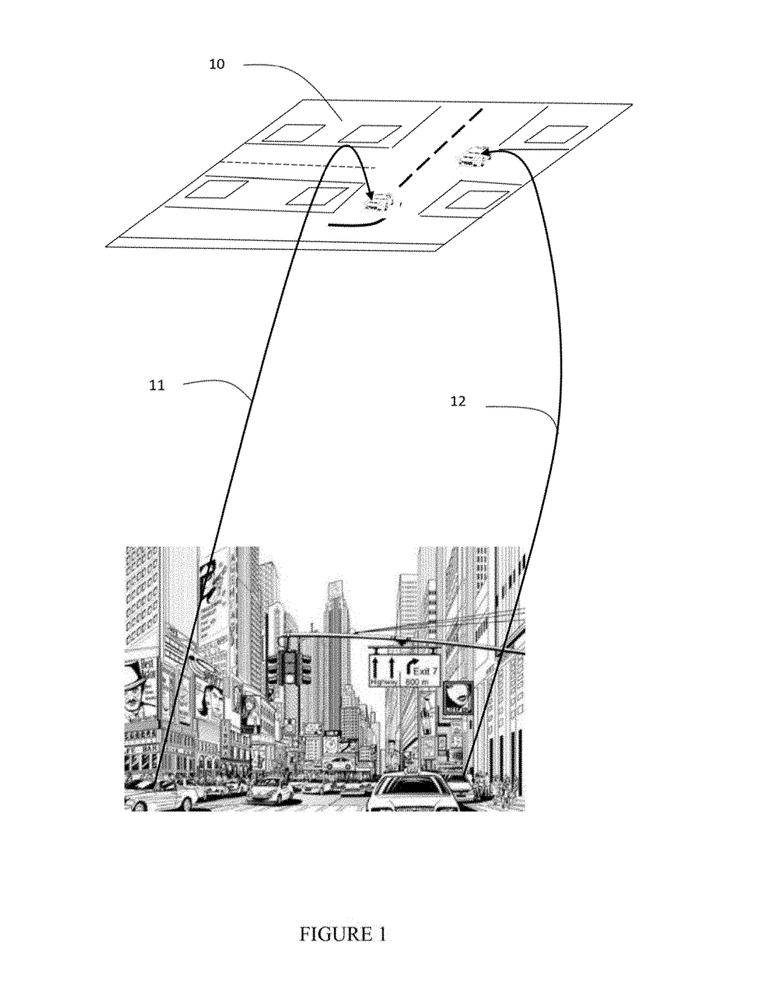

FIG. 1 illustrates an example of a map over an area 10 being the service area of a specific TBS. Respective cars 11, 12 updates the map with their respective GPS positions. The map is illustrated as being located in the cloud above the road system of the city. In an example of embodiment the present invention, a common map of the service area is updated with all the GPS positions and the map residing in the Cloud is accessible to all the road users driving inside the service area. If a road user is in need of cooperating with other road users in the area, the road user can select the respective road users by pushing the symbols representing their positions on a map being displayed locally in his car. The TC can ask the TBS to establish a communication channel between them, for example, a voice channel, and the cooperating road users can share knowledge about the current traffic situation. The identification of the TC addresses is based on searching with the GPS as discussed above.

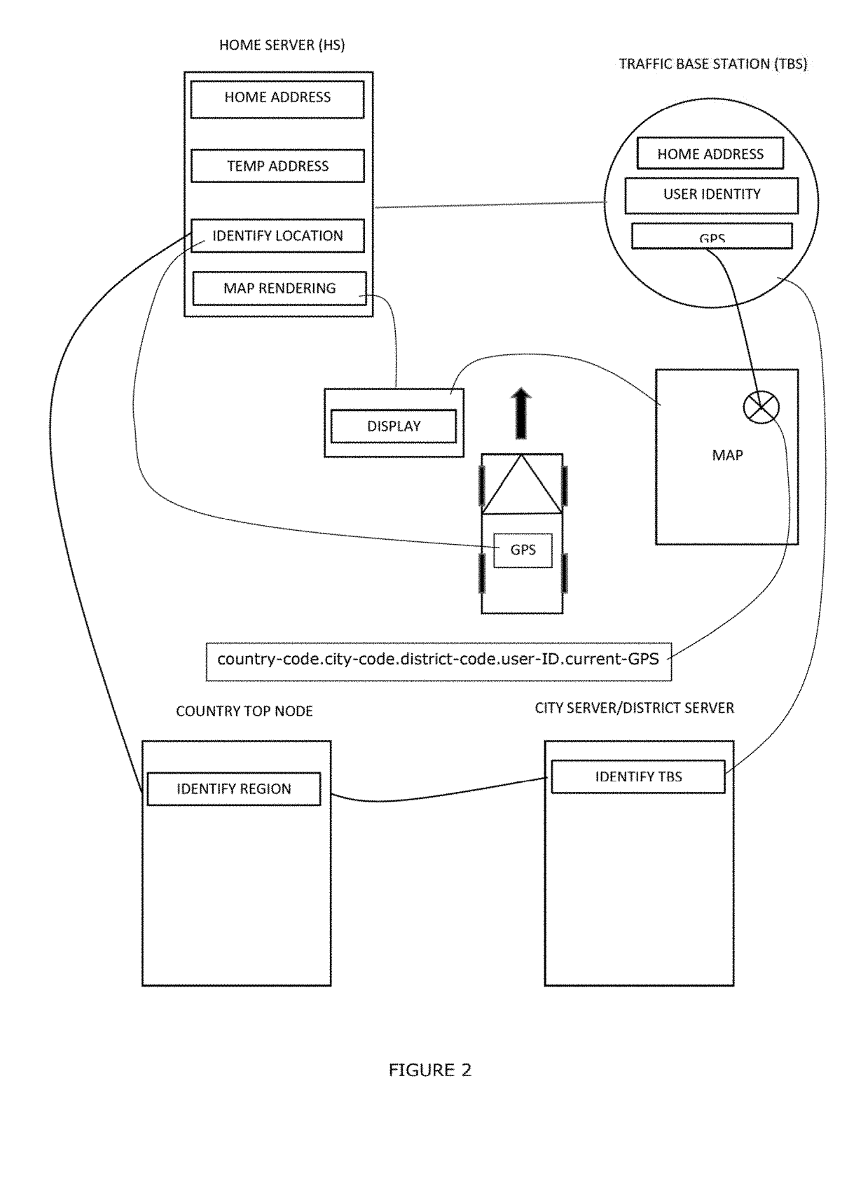

FIG. 2 depict respective server allocations and the basic paths between them when performing forward addressing as well as reverse addressing as discussed above. The respective servers may be physical servers, but can also be implemented as virtual servers residing in the cloud. A combination of physical and virtual servers is also possible. However, one main principle and consequence of the depicted example of topology of a system according to the present invention, is that the Home Servers HS keeping records of registered users is a distributed system in itself. Therefore, there is no physical limit on the number of users of the system. When one physical HS server is overloaded another physical or virtual server can be operational within the same district just by assigning a district server one and a district server 2. If TBS experience load problems the service area of a TBS can be reduced thereby reducing the amount of road users (cars) that can be located within the service area of the TBS, and hence avoiding overload. A new virtual and physical server can take over the burden of serving the road users previously operating inside the left over of the reduces service area of the original TBS.

When road users are driving around they will eventually drive out of the service area of first TBS and into the service area of a second TBS. Each TC of the respective road users will initially be brought into contact with a correct TBS when coming online as discussed above. The TC may also be configured to contact the home server HS at any time and ask the HS to establish or re-establish a contact with a TBS in the neighbourhood of the geographical position the TC is located according to a process identical with the process discussed above when turning on power in the morning.

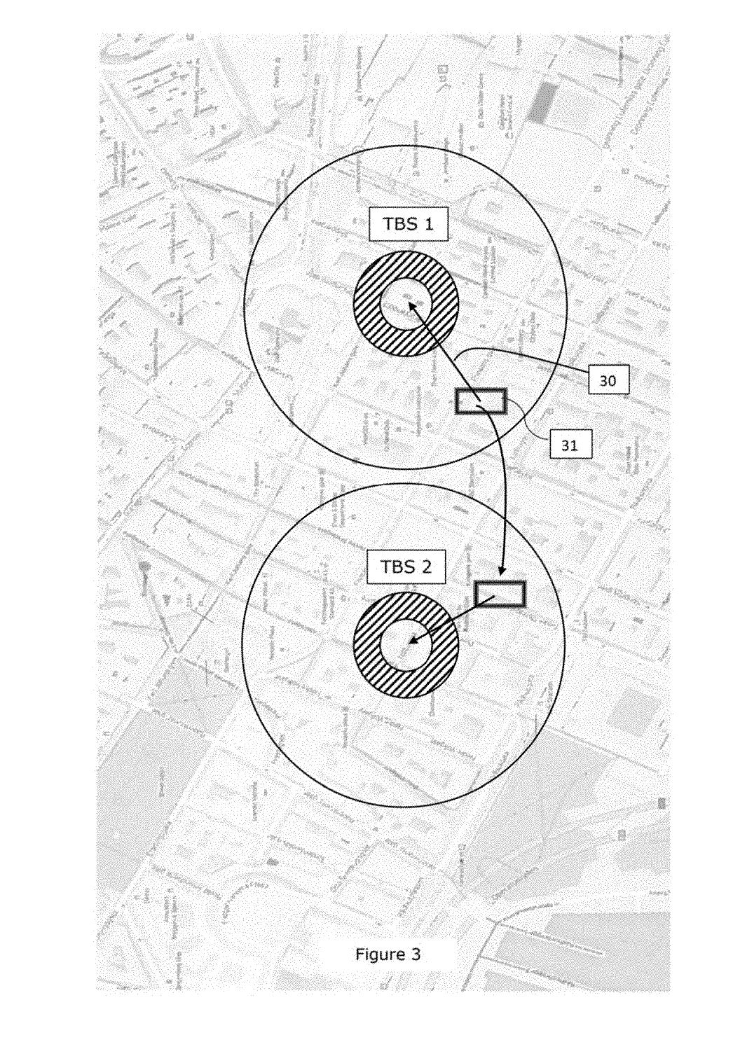

When an association between a specific TC and a specific TBS is established the TBS can submit to the TC the radius of the service area the TS is serving. Then the client TC can itself monitoring if the TC is located inside the radius of the serving area or not. When the TC discovers that it is not inside the service area of the previous TBS, the TC contacts the HS and receives an allocation to a next TBS serving the TC according to the shifted GPS position. It is possible to implement a soft handover between a first TBS and a second TBS in that the first TBS only signals the hand over when any process the TBS is part of with the specific TC (or road user), for example a voice communication with another road user, is terminated. It is important to understand that the service area concept is a virtual concept only used to achieve segmentation of users and association of respective users with respective segmented servers, i.e. a truly distributed system. FIG. 3 illustrates an example of handover from a TBS 1 to a TBS 2 of a car 30 driving from the service area of the TBS 1 into the service area of TBS 2.

The distributed architecture allows also any user of process somewhere in the word to contact and identify any type of moving object anywhere in the world. If the map of “the world” is scrolled to display a geographical area of interest, the GPS position of a selected point on the map section of interest can be used to identify and come in contact with the TBS serving the area comprising the selected GPS position. Then the common map of the service area residing in the Cloud can be displayed together with the moving positions of all moving objects around inside the service area. By following the examples of procedures discussed above, the identity and communication with the selected object is possible. The same effect is also possible when a select group of moving objects are selected, either by human interactions, or by a computer implemented process searching for the select group according to a specific search argument. A further interesting aspect of the solution of using physical and/or virtual traffic base stations TBS is the ability to perform correlated measurements of traffic on roads within the respective service areas of the TBS.

For example, when measuring distances between cars it is important to understand that there is noise present in GPS data that are collected. Even though the distance between cars is normally between two meters in city traffic, at any time the distance may decrease, for example because a car in front of another car slows down because the driver is trying to fetch a chocolate bar residing in a compartment in the car.

Another situation may be that the car in front is speeding up because the driver realize that he is late to a meeting and tries to catch up the time by speeding up.

Therefore, when recording GPS positions randomly between cars, the distance difference calculated may comprise noise generated by this random behavior. Further, many drivers do not maintain a constant speed when driving. It is normal to have some random movements of the feet controlling the accelerator pedal.

When the distance between cars is larger, the space around cars permits much larger fluctuations of distance variations between cars. If the speed is high, the observation is that cars tends to be concentrated over a distance in spaced apart groups. If random measurements of distances between cars is performed in any of these cases, a calculated signal would indicate a large fluctuation in distance measurements in the first case, and in the second case, the larger distances in between the groups of cars would be present in the calculated signal. If the signal is used to identify a possible queue problem as discussed above, the signal interpretation would correctly indicate that there is no probable queue problem.

It is a situation wherein the distance between cars are moderate that distance fluctuations may mask a signal indicating an upcoming queue problem.

Therefore, it is necessary to mitigate the randomness of GPS measurements to be able to identify a consistent decrease of distances between cars as early as possible.

One approach is to make time synchronized GPS readings, i.e. a selected group of cars submit their GPS position on the same point in time. Then the randomness of movement is less visible in the calculated distances. Then it is possible to establish a signal that might indicate the start of a congestion problem very early

The TBS may issue a synchronization signal to road users driving on roads inside the service area of the TBS, and the TBS may collect the time synchronized GPS readings from the TC for example. Synchronization of measurements over the Internet is disclosed in for example the standard IEEE 802.1A time, and if repeated, on the same points in time of each iteration of measurements.

According to an aspect of the present invention, a selected group of cars on a road inside the service area of a TBS can receive a synchronization signal and then read out their respective GPS positions in parallel. The cars can store the respective GPS positions locally in the cars, and an external system may address the selected cars and can read out the time synchronized GPS positions. The external system may combine measurements from a plurality of interconnected roads being served by different TBS servers. Then the system can identify a consistent increase or decrease of distances between the selected cars over large geographical areas.

The interpretation of the distance signal comprises investigating car distance development ahead of a road segment experiencing packing of cars. Based on such analysis the geographical point or limited area wherein the packing of cars starts can be identified by the fact that by definition the starting area will be adjacent to a road segment wherein car distances starts to increase again, or are just normal (has been normal all the time). The geographical point or limited area joining a road segment with packing of cars with a road segment with normal condition (or improving condition) is dynamically changing. If the joining area or point moves forward in the driving direction, the queue problem is increasing in this direction. If the joining area or point moves backwards the queue problem might be over, or the initial measurement of decreasing car distances was not an indication of a real queue problem.

According to an example of embodiment of the present system, a logical address may be amended with a dynamically updated GPS position identified by a GPS transceiver associated with a traffic client (TC) unit being carried with a road user when the road user is traveling around, thereby a logical address of the road user is transformed into a live physical address comprising the address fields:
country-code.city-code.district-code.user-ID.current-GPS.

Further, a physical address of the traffic client (TC) is maintained by the traffic client (TC) locally, and wherein external computer systems or other units of the distributed computer system, including process to process communications, read out the physical address of a specific traffic client (TC) by using a logical address of the TC.

In another example of embodiment of the distributed system according the present invention the logical address of a TC is the internet address associated with the road user, and is hosted by the HS. The home page may also function as the user profile of the road user as discussed above. The home page is updated with live information about the geographical position a road user is positioned on at any time. This may be achieved simply by configuring the traffic client (TC) to write or update the current GPS position of the traffic client (TC) from time to time, or an a regular basis on the home page associated with the road user. Then the logical address is the address of the home page associated with the road user, and the physical address is the combination of the home page address and the live GPS position on the home page. Each respective traffic base station TBS maintains a list of road users inside the respective service areas as discussed above. In this example of embodiment, the traffic base station TBS receives maintains respective Internet addresses of each respective road users inside the service area of the traffic base station TBS. When an external service provider like a traffic control center needs to contact specific road users in an area, the traffic base station TBS or stations in the area are contacted and a list of home address links (Internet addresses) of the road users is transferred to the service provider. Then the service provider can read out the GPS from each respective home page. The service provider can then create an association between respective GPS positions and the Internet address of each road user. Then messages and communication between the service provider and the respective road users can be established. The service provider can also maintain a map with GPS positions being updated by reading out the GPS position at any time. Then the map will be able to track the road users within the service are of a specific traffic base station TBS.

Further, a traffic client (TC) may track the distance between its own GPS position and a centre position of a service area served by a connected traffic base station (TBS), and when the traffic client (TC) identifies that it has moved outside the service area of the connected traffic base station (TBS), the traffic client (TC) requests a home server (HS) to identify a next traffic base station (TBS) serving the area the traffic client (TC) is now located in based on a GPS position reading of the current GPS position.

Further, a traffic base station (TBS) may provide the address of a next traffic base station when all processes involving the traffic base station (TBS) and the traffic client (TC) terminate.

Further, the traffic client (TC) is equipped with a high resolution GPS transceiver.

Further, a service provider may communicate with a respective road user based on a plotted GPS position on a map, by I) Identifying a traffic base station In an area surrounding the plotted GPS position; II) reading out the home page addresses and the current GPS position updated on the respective home pages of road users in the service area of the traffic base station (TBS), and superimpose a map layer on the map with a pointer to the respective home pages of each road user on the respective GPS positions received from the home page; and III) identify which pointer is closest to the plotted GPS position.

According to an example of embodiment a method identifying traffic congestions on roads comprising a distributed system according to the present Invention, wherein a traffic base station (TBS) is configured to perform the steps of: initiating a time correlated reading of GPS positions from a plurality of cars driving on a road in a same driving direction within the service area of the traffic base station; recording the time correlated GPS positions; and initiating an analysis of a series of correlated GPS positions to determine if there Is a consistent decreasing distance between the cars, or if there is a consistent Increase of the distance between the cars.

Further, the measurement may be based on a synchronized read out of GPS positions from a first car and a second car, wherein the distance between the first and second car is at least ten car lengths.

Further, a third car may be located in between the first and second car.

Further, the GPS positions may be from GPS transceivers with increased resolution.

1. A distributed traffic guidance and information system comprising:
a home server (HS) hosting user profiles of registered road users living inside a limited district of a city or a rural region;
the home server (HS) is configured to assign a unique user identification (user-ID) of each registered road user being unique with respect to user registrations of other road users being registered in other home servers (HS) serving other districts or rural regions;
wherein each registered road user is identified by a logical address comprising address fields comprised of country-code.city-code.district-code.user-ID, wherein user registrations of the distributed traffic guidance and information system are distributed, and wherein respective address fields of the logical address points to geographical areas;
wherein the home server (HS) receives GPS positions from a traffic client (TC) when the traffic client (TC) comes online with the home server (HS), or the home server (HS) requests a transfer of the GPS positions from the traffic client (TC);
wherein the home server (HS) is configured to identify a country code of the country the GPS positions are located within, and then a top country server identifies a city the road user is located inside the country, and a city server identifies a district the road user is located within, and the district server identifies a traffic base station serving road users within an area the GPS positions are within, and the traffic client (TC) and the traffic base station (TBS) connect to each other.

2. The distributed system according to claim 1, wherein the logical address is amended with a dynamically updated GPS position identified by a GPS transceiver associated with a traffic client (TC) unit being carried with the road user when the road user is traveling around, and the logical address is transformed into a live physical address comprising the address fields: country-code.city-code.district-code.user-ID.current-GPS.

3. The distributed system according to claim 2, wherein the traffic base station (TBS) provides the address of a next traffic base station when all processes involving the traffic base station (TBS) and the traffic client system (TC) terminates.

4. The distributed system according to claim 1, wherein the traffic client (TC) is equipped with a high resolution GPS transceiver.

5-6. (canceled)

7. A method of identifying congestion of cars on roads by using a distributed system according to claim 1, wherein a traffic base station (TBS) is configured to perform the steps of:
initiating a synchronisation step when reading GPS positions from a plurality of cars driving on a road in a same driving direction within a service area of the traffic base station (TBS),
recording the time synchronized GPS positions,
initiating an analysis of the synchronized GPS positions to determine if there is a consistent decreasing distance between the cars, or if there is a consistent increase of a distance between the cars.

8. The method according to claim 7, wherein the measurement is based on a synchronized read out of GPS positions from a first car and a second car, wherein the distance between the first and second car is at least ten car lengths.

9. The method according to claim 8, wherein a third car is located in between the first and second car.

10. The method according to claim 7, wherein the GPS positions are from GPS transceivers having increased resolution.

11. The distributed system according to claim 1, wherein the physical address of the traffic client (TC) is maintained by the traffic client (TC) locally, and wherein external computer systems or other units of the distributed system including process to process communications read out a physical address of a specific traffic client (TC) by using the logical address of the TC.

12. The distributed system according to claim 1, wherein a district code of the logical address is associated with a district server.

13. The distributed system according to claim 1, wherein the district server is supervising a plurality of traffic base stations (TBS) being configured to serve road users being inside different adjacent limited service areas served by the respective traffic base stations (TBS).

14. The distributed system according to claim 1, wherein the traffic client (TC) updates a user profile hosted by the home server (HS) with a temporary physical address comprised of the respective identified temporary address fields.

15. The distributed system according to claim 1, wherein the traffic client (TC) tracks the distance between its own GPS positions and a center position of the service area served by a connected traffic base station (TBS), and when the traffic client (TC) identifies that it has moved outside the service area of the connected traffic base station (TBS), the traffic client (TC) requests the home server (HS) to identify a next traffic base station (TBS) serving the area the traffic client (TC) is now located on based on a GPS position reading of a current GPS position.

16. The method according to claim 7, wherein an external computer system is configured to acquire measurements from a plurality of traffic base stations and thereby monitoring an increased area if there is a probable upcoming traffic congestion somewhere inside the increased geographical area.
